(19) United States
(12) Patent Application Publication
(10) Pub. No.: US 2002/0159571 A1
(43) Pub. Date: Oct. 31, 2002

(54) System for controlling use of and access to a communication device or other second system based upon an identifying biological characteristic of a user

(76) Inventor: Michael Stock, Gladstone, MO (US)

Correspondence Address: THOMAS B. LUEBBERING, HOVEY, WILLIAM, TIMMONS & COLLINS, Suite 400, 2405 Grand, Kanses City, MO, 64108, US

(21) Appl. No.: 09/810,686

(22) Filed: Mar. 16, 2001

(51) Int. Cl. H04M 1/64; G06K 9/00

(52) U.S. Cl. 379/88.02; 382/115

(57) ABSTRACT

A system (10) for controlling use of or access to a second system, such as a telephone or other communication device, based upon an identifying biological characteristic of a user. The system comprises the telephone (12), including a keypad (14); a display (18); a biometric input device (20); and a controller (24). The controller (22) includes a compact single board computer (24) with an embedded operating system, such as a microkernel version of the Linux operating system, requiring approximately eight megabytes of memory. A person desiring to use the telephone (12) presents the biological characteristic, such as a fingerprint, to the biometric input device (20). A biometric template is created and compared to a resident template database of authorization information. Using a “one-to-many” search engine, requiring approximately 1 megabyte of memory, the present invention is able to perform a linear search of 500 templates within 1.5 seconds or less.

A computer program listing appendix containing the source code of a computer program that may be used with the present invention is incorporated herein by reference and appended hereto as one (1) original compact disk, and an identical copy thereof, containing a total of seven (7) files as follows:

| Date of Creation: | Size (Bytes): | Filename: |
|---|---|---|
| Mar. 7, 2001 09:23a | 5,328 | BIOMOUSE.C |
| Mar. 7, 2001 09:24a | 701 | BIOMOUSE.H |
| Mar. 7, 2001 09:24a | 116 | BZERO.C |
| Mar. 7, 2001 09:24a | 5,148 | DBIAPI.H |
| Mar. 7, 2001 09:23a | 7,570 | LCDENR˜1.C |
| Mar. 7, 2001 09:22a | 7,770 | LCDHEA˜1.H |
| Mar. 7, 2001 09:22a | 15,533 | LCDTRY.C |

### BACKGROUND OF THE INVENTION

1. Field of the Invention

The present invention relates to systems for monitoring and controlling use of and access to other systems. More particularly, the invention relates to a control system having an embedded operating system for monitoring and controlling use of and access to a second system, such as a telephone or other communication device, based upon an identifying biological characteristic of a user.

2. Description of the Prior Art

It is often desirable to monitor and control use of and access to certain restricted systems or sensitive areas, though a constant human presence is impractical or inefficient. This is particularly true, for example, in prisons where the restricted system is a communication device, commonly a telephone, and the users are inmates.

In such a setting, existing monitoring and control systems typically require the inmate to enter, using the telephone keypad, a string of between eighteen and twenty-eight numbers representing the inmate's personal identification number (PIN) and the telephone number to be called. A local computer matches the PIN to a database and checks for unauthorized telephone numbers, including 800 and 900 numbers and those corresponding to judges, witnesses, and victims associated with the inmate or the inmate's case. If, based upon the PIN, the desired telephone number is not restricted, the call is placed. The same local computer records the call length, date, time, and other pertinent information, which is later downloaded to a remote computer for billing. Those with skill in the art will appreciate that such existing systems suffer from serious disadvantages and great potential for abuse.

One well-known problem is that PIN numbers, which may be stolen, traded, or bought, are a notoriously unreliable method of personal identification. In one common scenario, for example, a first inmate desiring to call and intimidate a witness steals, trades, or buys a second inmate's PIN, where the second inmate is not restricted from calling the witness who is associated only with the first inmate's case. As the second inmate may be far from the telephone or have a similar alibi when the call is made, investigators are left with no way to positively identify the inmate who placed the call. The illicit use of another's PIN number can also wreak havoc with call billing schemes, causing inmates to be billed for calls they did not make.

Another well-known problem relates to the difficulty of remembering and correctly entering up to twenty-eight numbers, including the PIN and dialing numbers, which can result in user frustration, incorrect billing, and calls to wrong parties. For example, transposing numbers or striking two keys at once are common mistakes. Furthermore, though many of these problems result in aborted attempts or calls placed to wrong parties, the telephone provider (i.e., the prison) may still incur connection, third-party service provider, long distance, or other costs or fees.

Biometric identification systems have been used, in lieu of PIN numbers, to monitor and control use of and access to certain restricted systems or sensitive areas. Unfortunately, existing biometric identification systems require such prohibitively large amounts of memory and processing ability as to be too costly and generally impractical for many applications other than validating a prior preliminary identification. Using such a biometric system in the prison setting described above, for example, would require that each telephone be provided with its own Windows-based personal computer to receive the biometric input data and search a database of stored biometric templates in an attempt to find a match, with the search possibly requiring several minutes to complete.

One solution has been to use PINs for searching the database and use biometrics only for validation once a match has been made. Though solving some problems, such as illicit use of another's PIN, other problems, such as remembering and correctly entering long strings of numbers, remain.

Because PIN-based and existing biometric-based control systems suffer from the above-identified problems and potentials for abuse, a need exists for an improved control system.

### SUMMARY OF THE INVENTION

The present invention solves the above-described and other problems and provides a distinct advance in the art of control systems, being operable to control use of or access to a second system based upon an identifying biological characteristic of a user. Although the present invention is broadly applicable to and may be adapted to function with a variety of different second systems, it is particularly suited for controlling use of and access to communication devices, such as telephones, by prison inmates.

A preferred embodiment of the present invention comprises a telephone, including conventional telephone circuitry and a keypad; a display; a biometric input device; and a controller. The controller includes an extremely compact single board computer, or “minimized open personal computer system” (MOPS) device, running an embedded, microkernel version of the Linux operating system requiring approximately only eight megabytes of memory. The MOPS device comprises inherently reliable solid state components and provides substantial memory resources and processing ability in a relatively inexpensive package small enough to fit within the telephone housing.

The controller is interposed between the keypad and telephone circuitry, and the telephone is normally disabled such that no dial tone is heard nor call-making possible. An inmate desiring to make a call places his or her finger on the biometric input device and a template thereof is produced; no PIN is required. The controller receives the digitized biometric data and searches a template database of authorization information for a match. Using a “one-to-many” search engine, requiring approximately only 1 megabyte of memory, the performance of the present invention is so improved over the prior art that a linear search of 500 templates requires 1.5 seconds or less—orders of magnitude faster than the existing art using a full-sized personal computer. If a match is not found, the telephone remains disabled. If a match is found, a list of authorized telephone numbers appears on the display, the inmate selects one, using the keypad to scroll through the list, and the controller automatically causes the telephone circuitry to dial the number and make the connection.

PINs, and the problems associated therewith, are completely eliminated from the present system, meaning that each user can be positively identified and associated with a particular telephone call. Because desired telephone numbers are selected from a list limited to authorized numbers for a particular user, it is virtually impossible for an inmate to call a restricted or wrong number, thereby eliminating improper billing and unnecessary connection fees and other costs to the telephone provider.

Furthermore, each instance of the present system is fully Internet compatible and has its own Internet protocol (IP) address, allowing for centralized data storage, control, and management of a number of telephones, each equipped with its own instance of the present invention. Thus, billing information, general display data, and user information, including biometric data and restricted and authorized telephone numbers, can be updated from a single centralized location.

These and other novel features of the present invention are described in more detail in the section titled DETAILED DESCRIPTION OF A PREFERRED EMBODIMENT, below.

### BRIEF DESCRIPTION OF THE DRAWING FIGURES

The present invention is described in detail below with reference to the attached drawing figures, wherein:

FIG. 1 shows a block diagram representation of a preferred embodiment of hardware components of the present invention; and

FIG. 2 shows a block diagram representation of the steps involved in the operation of the embodiment of the present invention shown in FIG. 1.

### DETAILED DESCRIPTION OF A PREFERRED EMBODIMENT

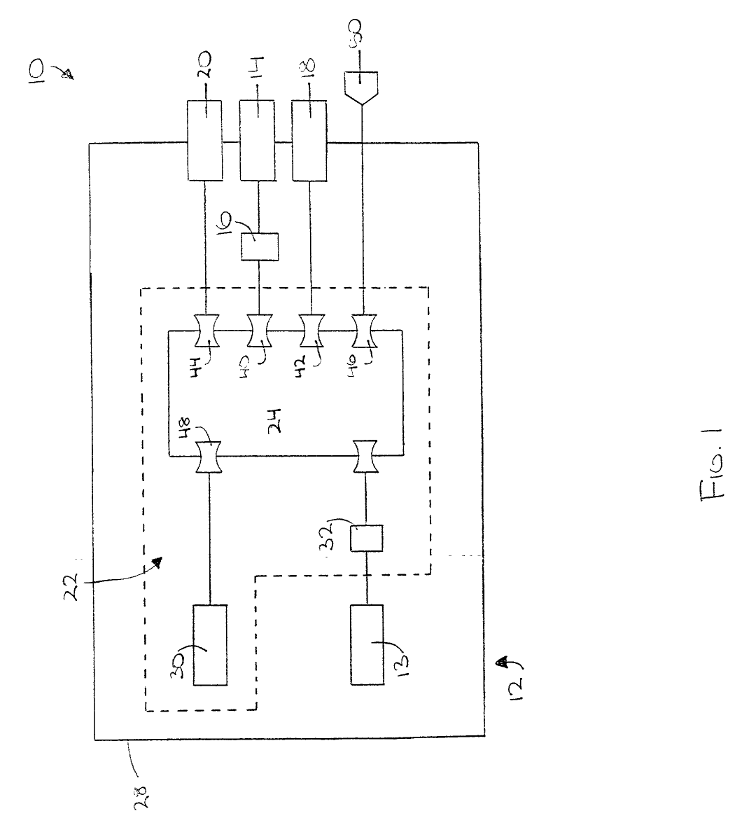

Referring to FIG. 1, a system 10 is shown constructed in accordance with a preferred embodiment of the present invention and operable to control use of a telephone based upon an identifying biological characteristic of a user. Though described for illustrative purposes in terms of this specific application, the present invention has broad applicability not limited to a particular one or type of associated second systems or contexts. The system 10 broadly comprises a telephone 12, including telephone circuitry 13 and a keypad 14; a keypad encoder 16; a display 18; a biometric input device 20; and a controller 22, including a MOPS device 24.

The telephone 12 is a conventional “plain old telephone system” (POTS) telephone connected to and operable via the telephone circuitry 13 to place calls over a telecommunications network. The telephone 12 includes a housing 28, within or upon which all of the other components of the preferred system 10 are located. The telephone 12 also includes a conventional twelve-key keypad 14 for providing input.

As noted above, the present invention has application to a wide range of communication devices, including computer, cellular, wireless, and satellite-based communication systems. With that in mind, those with skill in the art will appreciate that the keypad 14 of the illustrative embodiment should be broadly viewed as being merely an input device which may take different form depending upon the nature of the second system.

The keypad encoder 16 is preferably a solid state device for operatively adapting the keypad 14 to the MOPS device 24, being interposed therebetween and operable to condition input signals generated by the keypad 14 such that the signals appear to the MOPS device 24 to have originated from a conventional AT-type computer keyboard. The encoder 16 may not be required in every application.

The display 18 is preferably a liquid crystal display (LCD) operable to display text messages in the form of two lines of twenty-four characters per line. The nature, size, and capabilities of the display 18 are design and application dependent. MOPS devices, however, are typically configured to interface with particular types of displays such that an adapter, whether based in hardware, software, or firmware, may be required if other types of displays are desired.

The biometric input device 20 is operable to capture and digitize biometric input to produce a biometric template. Though the preferred system 10 is fingerprint-based and uses a fingerprint scanner 20, other identifying biological characteristics and corresponding biometric input devices may be used, such as, for example, a retina, voice, or hand geometry scanner. The preferred biometric input device 20 includes a 500 dots-per-inch (DPI) imaging system for producing an average template size of 350 bytes.

The controller 22 is a central component of the system 10, being interposed between the various input devices 20,14 and the telephone circuitry 13, and operable, in conjunction with the source code described below, to accept biometric input, identify the user based upon the input, and control use of the telephone circuitry 13 based upon the identification result. The preferred controller 22 comprises a hard drive 30; a PC-104 telephone modem 32; and the MOPS device 24. The hard drive 30 is preferably a conventional solid state hard disk drive providing mass memory storage for access and use by the MOPS device 24. The PC-104 telephone modem 32 operatively interfaces the controller 22 with the telephone circuitry 13.

The MOPS device 24 is preferably a PC-104 compatible single board computing device incorporating an AMD5×86-P75 (or better) processor with a clock speed of 133 MHz, as is available, for example, from JUMPtec Industrielle Computertechnik AG. Such a device 24 is essentially a personal computer (PC) with a different form factor and reduced power requirements and signal drive, and is amenable to most of the program development tools available for full-sized PCs, thereby reducing development costs and time.

Those with skill in the art will appreciate that numerous configuration and component options are available for MOPS devices. The preferred device 24, however, includes, at a minimum, a keyboard interface 40 operable to couple the MOPS device 24 with the keyboard encoder 16; an RS-232 serial port 42 for coupling with the LCD 18 via a standard RS-232 serial cable; a parallel port 44 for coupling with the biometric input device 20; a network interface card 46 for coupling with a TCP/IP communications network 50, such as a local area network (LAN), wide area network (WAN), or the Internet; and an IDE hard disk interface 48 for coupling with the hard disk drive 30.

Though not shown, it will be appreciated that the controller 22 and other components of the system 10 can be connected to an interruptible power supply able to maintain the system 10 operational through power spikes, surges, lulls, brownouts, blackouts, and other power problems.

Preferred source code is included as a microfiche appendix for use in conjunction with the above-described preferred system 10. The source code is operable to enroll potential users into the database of templates; capture a user's biometric image, compare the image to the templates in the database; match the image and retrieve a user identification number; control the display; and enable or cause the telephone circuitry 13 to make a call. The source code may be implemented as a single program or a combination of operatively interrelated source code segments written and compiled in any suitable high or low level programming language, such as C++, Java, or Assembly, keeping in mind the memory and processing limitations of the preferred computing device 24. It is contemplated that the compiled object code will be stored on the hard disk drive 30 of the controller 22 and will control the functionality of the MOPS device 24.

As provided in the microfiche appendix, Lcdheader.h defines the LCD panel communication and the display subroutines. Biomouse.h provides for user-defined settings and security settings. Biomouse.c provides an interface for the system, opens and closes drivers, communicates image capture options, and detects image capture settings. Lcdtry.c is the main program operable to accomplish much of the functionality of the present invention. Enroll.c provides a mechanism for allowing user enrollment and updating of the template database via the telephone 12 or other communication device. ModifiedEnroll.c provides an alternative mechanism for user enrollment and remote updating of the template database via the network interface card 46 and communications network 50.

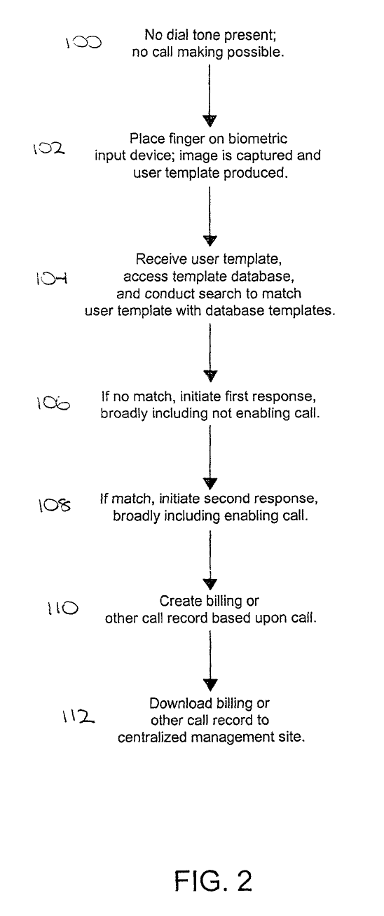

Referring to FIG. 2, in operation, assuming prior installation of all necessary hardware, software, and firmware, the controller 22 prevents normal use of the telephone 12 such that no dial tone is present and no call making possible, as depicted in box 100. A user desiring to make a call approaches the telephone 12 and places his or her finger on the biometric input device 20, as depicted in box 102. The device 20 captures an image of the user's fingerprint, and the controller 22 converts the fingerprint image to a biometric template.

The controller 22 then accesses the template database stored on the hard drive 30, and conducts a linear “one-to-many” search in an attempt to identify the user, as depicted in box 104. If no match is made, a first response follows, the nature of which is application and design dependent, but broadly including not enabling the call, as depicted in box 106. One contemplated first response is to allow the user to immediately enroll and enter any required information, including their unique template, via the telephone 12. Once such enrollment is accomplished, the user is able to proceed with making his or her call. Another contemplated first response is to simply deny the user and not allow the call until he or she has properly enrolled at a centralized management site, and the enrollment information has been downloaded to the hard drive 30 via the interface card 46 and network 50.

If a match is successfully made, a second response follows, the nature of which is also application and design dependent, but broadly including enabling the call, as depicted in box 108. One contemplated second response is to present via the display 18 a list of authorized telephone numbers. The user can scroll through the numbers and select one using the keypad 14, after which the controller 22 via the telephone modem 32 causes the telephone circuitry 13 to initiate the call. Another contemplated second response is to simply allow the properly identified user to use the keypad 14 in a normal manner to call any telephone number.

Other responses and control functions and features are also contemplated, including using the controller 22 to limit the connection time of an otherwise authorized and successfully placed call, or initiating an alarm or other signal in response to improper use or attempted access. As mentioned above, an advantage of the MOPS device 24 and embedded Linux operating system is the ability to easily and inexpensively develop additional responses, functions, and features as desired.

In certain applications, including the prison scenario, a billing record is created based upon the user's identity, the telephone number called, the connection time, and other relevant information, as depicted in box 110. These billing or similar access and use records can be downloaded via the interface card 46 and network 50 to a centralized management site, as depicted in box 112.

It should also be noted that the present system does not interfere with other call restriction systems, such as an Omni call box, or T-Netix or Evercom operating platform.

Although the invention has been described with reference to the preferred embodiment illustrated in the attached drawing figures, it is noted that equivalents may be employed and substitutions made herein without departing from the scope of the invention as recited in the claims. For example, those with skill in the art will appreciate that numerous different embodiments of hardware, software, firmware or combinations thereof exist for practicing the present invention. Accordingly, the present invention should not be viewed as limited to the particular illustrative embodiment shown and described.

Having thus described the preferred embodiment of the invention, what is claimed as new and desired to be protected by Letters Patent includes the following:

1. A first system for controlling use of a second system based upon an identifying biological characteristic of a user, the system comprising:
a biometric input device operable to capture an input relating to the identifying biological characteristic;
a memory containing a database of information sufficient to identify at least one authorized user based upon the identifying biological characteristic; and
a controller having an embedded operating system and operable to receive the input, compare the input to the information to produce one of a plurality of possible comparison results, and, based upon the comparison result, control use of the second system.

2. The system as set forth in claim 1, the identifying biological characteristic being a fingerprint, the biometric input device being operable to capture an image of the fingerprint of the user.

3. The system as set forth in claim 1, the identifying biological characteristic being a retina print, the biometric input device being operable to capture an image of the retina of the user.

4. The system as set forth in claim 1, the identifying biological characteristic being a voice print characteristic, the biometric input device being operable to capture input relating to the voice print characteristic of the user.

5. The system as set forth in claim 1, the embedded operating system being a microkernel operating system.

6. The system as set forth in claim 1, the second system being a communication device.

7. A system for controlling use of a communication device based upon an identifying biological characteristic of a user, the system comprising:
a biometric input device operable to capture input relating to the identifying biological characteristic;
an interface operatively coupling the system to the communication device;
a memory containing a database of information sufficient to identify at least one authorized user based upon the identifying biological characteristic; and
a controller having an embedded operating system and operable to receive the input, compare the input to the information to produce one of a plurality of possible comparison results, and, based upon the comparison result, control use of the communication device.

8. The system as set forth in claim 7, the identifying biological characteristic being a fingerprint, the biometric input device being operable to capture an image of the fingerprint of the user.

9. The system as set forth in claim 7, the identifying biological characteristic being a retina print, the biometric input device being operable to capture an image of the retina of the user.

10. The system as set forth in claim 7, the identifying biological characteristic being a genetic characteristic, the biometric input device being operable to capture input relating to the genetic characteristic of the user.

11. The system as set forth in claim 7, the embedded operating system being a microkernel operating system.

12. The system as set forth in claim 7, the second system being a telephone.

13. The system as set forth in claim 7, further comprising a display device operable to communicate with the user and present information.

14. The system as set forth in claim 13, the display device being operable to present use options for selection by the user, the use options including one or more telephone numbers.

15. The system as set forth in claim 14, the controller being operable to cause the communication device to enable communication based upon the user's selection.

16. A combination of source code segments for controlling use of a communication device based upon an identifying biological characteristic of a user, the combination of source code segments being executed by a control device having an embedded operating system, the combination of source code segments comprising:
a first code segment operable to receive and store enrollment information including information sufficient to identify at least one authorized user based upon the identifying biological characteristic;
a second code segment operable to receive input and compare the input to the enrollment information to produce one of a plurality of possible comparison results, and
a third code segment operable, based upon the comparison result, to control use of the communication device.

17. The combination of source code segments as set forth in claim 16, further comprising a fourth code segment operable to generate a record of the use of the communication device.

18. The combination of source code segments as set forth in claim 16, the control device being a single board computer.

19. The combination of source code segments as set forth in claim 16, the embedded operating system being a microkernel operating system.
